(19) United States
(12) Patent Application Publication
(10) Pub. No.: US 2005/0021942 A1
(43) Pub. Date: Jan. 27, 2005

(54) Process for updating a revocation list of noncompliant keys appliances or modules in a secure system for broadcasting content

(76) Inventors: Eric Diehl, Liffre (FR); Alain Durand, Rennes (FR)

Correspondence Address: Joseph S Tripoli;Thomson Licensing Inc, Patent Department, P O Box 5312, Princeton, NJ, 08543-5312, US

(21) Appl. No.: 10/499,787

(22) PCT Filed: Dec. 20, 2002
(86) PCT No.: PCT/EP02/14639

(30) Foreign Application Priority Data
Dec. 28, 2001 (FR) 01/17139

(51) Int. Cl. H04L 9/00

(52) U.S. Cl. 713/158

(57) ABSTRACT

The process consists in receiving in a reception device a content from a content provider to which is attached a unique identifier of most recent revocation list, the revocation list containing identifiers of keys, of appliances or of modules regarded as noncompliant by a trusted third party. The revocation list identifier received is compared with a revocation list identifier stored in the reception device and, in case of difference between the identifiers: one downloads the most recent revocation list to the said reception device; or one awaits the reception of the most recent revocation list with a next content. The invention also relates to a process for presenting a content received according to the above process.

### FIELD OF THE INVENTION

The present invention pertains in a general manner to the field of the anticopy protection of digital contents. It relates more especially to a process for updating a revocation list of noncompliant keys, appliances or modules in a secure system for broadcasting content.

### STATE OF THE ART

The transmission of digital data representative of contents through a communication network poses problems of protection of the data exchanged and of management of permissions or prohibitions to copy the data.

To remedy these problems, manufacturers of multimedia hardware have proposed solutions making it possible to transmit contents in digital form while preventing the illicit copying of these contents. These solutions generally involve the use of public-key cryptographic systems in which private/public key pairs are generated by a trusted third party (for example a certifying authority), as well as the use of so-called compliant appliances or modules.

Unfortunately, sometimes a private/public pair of keys is pirated, that is to say a “pirate” succeeds in obtaining the private key of the pair of keys, or else a compliant appliance or module, containing for example a secret, is pirated, that is to say the “pirate” obtains the secret.

This is why it Is known in a system for secure broadcasting of content to manage a revocation list containing identifiers of keys, of appliances or of modules which are no longer regarded as compliant by the trusted third party since the latter has become aware of the fact that they have been pirated. This revocation list must be communicated to all the participants in the system so that the keys, appliances or modules which are no longer compliant can no longer be used. For example, the compliant appliances of the system will refuse to communicate with a noncompliant appliance or with an appliance transmitting a noncompliant key.

In order for this to be effective, it is necessary for the compliant appliances to always have the latest up-to-date revocation list.

Moreover, nowadays it is common to use mass-market electronic appliances such as a television, a DVD reader (the initials standing for “Digital Versatile Disc”), a digital recording device (in particular video recorder, DVD recorder or hard disk) or a computer in a digital home network.

In this case, to ensure that the various appliances do indeed possess an up-to-date revocation list, it is known to routinely append the latest up-to-date revocation list to any content which enters the home network, the content being sent by a content provider who obtains the latest up-to-date revocation list from the trusted third party.

Another known solution consists in adding a date of validity to any revocation list which is transmitted to the network. After this date, it is no longer possible for any new content to be received on the domestic network so long as a new up-to-date revocation list has not been received. It is therefore necessary for at least one appliance of the home network to request from the content provider for example an update of the revocation list.

However, these known techniques have a certain number of drawbacks.

Routinely sending the latest up-to-date revocation list with any content transmitted increases the cost of sending the content since a part of the bandwidth is allotted to the transmission of the revocation list. Moreover, a pirate could always replace the revocation list transmitted with the content by an older list not containing the latest updates.

On the other hand, adding a date of validity to the revocation list involves more complex management at the level of the appliances of the home network. To achieve a good level of security, the revocation lists must be updated frequently. Moreover, if a new revocation list is sent before the end of the period of validity of the previous one, it may possibly be erased by a pirate without the appliances of the home network realizing, since the date of validity of the revocation list stored in the network will not have expired.

### DESCRIPTION OF THE INVENTION

The present invention aims to solve the aforesaid problems.

Its subject is a process for updating a revocation list containing identifiers of keys, of appliances or of modules regarded as noncompliant by a trusted third party in a secure system for broadcasting content consisting in receiving in a reception device a content from a content provider, characterized in that a unique identifier is allotted to each update of the revocation list by the trusted third party, the identifier of the most recent revocation list being attached to the content received in the reception device, and in that the process furthermore comprises a step consisting in comparing the revocation list identifier received with a revocation list identifier stored in the reception device and, in case of difference between the identifiers:
in downloading the most recent revocation list to the said reception device; or
in awaiting the reception of the most recent revocation list with a next content.

Thus, one avoids transmitting the entire revocation list with each sending of a new content and a new revocation list is sent only when necessary, following an updating of this list.

The invention also relates to a process for receiving a content by a reception device in a secure system for broadcasting content in which a revocation list, drawn up by a trusted third party, contains identifiers of keys, of appliances or of modules regarded as noncompliant by the trusted third party, characterized in that a unique identifier is allotted to each update of the revocation list, the identifier of the most recent revocation list being attached to the content received by the reception device. The process furthermore comprises a step consisting in comparing the revocation list identifier received with a revocation list identifier stored in the reception device, and in case of difference between the identifiers: in downloading the most recent revocation list to the reception device; or in awaiting the reception of the most recent revocation list with a next content.

According to a particular characteristic of the invention, the revocation list unique identifier is an update index of the revocation list.

According to another characteristic of the invention, the identifier of most recent revocation list which is received with the content is included in a part protected by encryption or by authentication of the content The revocation list identifier therefore cannot be eliminated or modified easily by a pirate.

According to a particular embodiment of the invention, the revocation list can contain one or more elements belonging to the set comprising:
at least one serial number of a public key generated by the trusted third party and regarded as noncompliant by the trusted third party;
at least one serial number of an appliance regarded as noncompliant by the trusted third party;
at least one serial number of a module regarded as noncompliant by the trusted third party;
at least one local network secret key identifier serving to protect contents against illicit copying;
at least one local network secret key serving to protect contents against illicit copying;
at least the result of a calculation function, in particular a hash function, applied to a local network secret key serving to protect contents against illicit copying.

According to another advantageous characteristic of the invention, for each element of the revocation list, its revocation index corresponding to the update index of the list at the moment of the insertion of the element into the revocation list is furthermore stored.

The subject of the invention is also a process for presenting a content received in compliance with the process as described hereinabove which comprises the steps consisting for a content presentation device in: verifying whether the most recent revocation list at the disposal of the reception device does not contain any element relating to at least one key, one module or one appliance used by the reception device; and if the revocation list does not contain any of the said elements, continuing the process so as to present the content to a user, otherwise, stopping the process.

As a variant of the above process, if the revocation list contains at least one of the said elements (that is to say an element relating to at least one key, one module or one appliance used by the reception device), the process is continued with the steps consisting in: comparing the revocation list update index attached to the content with the revocation index of the said element; and, if the revocation list update index attached to the content is less than the revocation index of the said element, continuing the process so as to present the said content to a user, otherwise, stopping the process.

### BRIEF DESCRIPTION OF THE DRAWINGS

The invention will be better understood on reading the description which follows, given merely by way of example and while referring to the appended drawings in which:

FIG. 1 diagrammatically represents a secure system for broadcasting content in a digital home network in which the invention is implemented;

FIGS. 2 and 3 diagrammatically represent processes implemented, according to the invention, in devices of FIG. 1.

### DETAILED DESCRIPTION OF EMBODIMENTS OF THE INVENTION

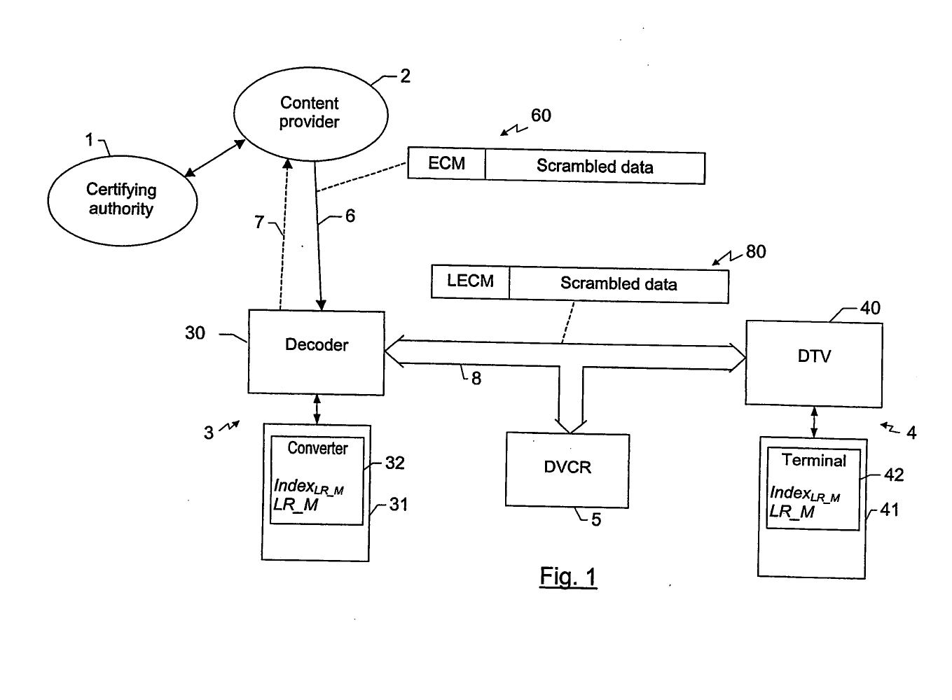

In FIG. 1, we have represented a secure system for broadcasting content comprising a certifying authority 1, which constitutes the trusted third party in the process of the invention, a content provider 2 and a digital home network comprising a content reception device 3, a content presentation device 4 and a recording device 5 which are linked together by a digital bus 8 which is, for example, a bus according to the IEEE 1394 standard.

The certifying authority 1 generates in particular the private/public key pairs used by the various devices of the system, the public keys being contained in certificates signed by the certifying authority as is known to the person skilled in the art.

The certifying authority 1 is linked to the content provider 2, which is for example a broadcaster of pay televised programmes. A single content provider 2 is represented in FIG. 1 but, naturally, the invention applies also to the case where several different content providers are linked to the certifying authority so as to deliver contents to users. Another content provider may in particular be a distributor of music programmes broadcast via the Internet.

According to the invention, the certifying authority 1 keeps up to date a revocation list which contains identifiers of keys, of appliances or of modules which are no longer regarded as safe and in which the certifying authority no longer places any trust, in particular since it has detected that the keys, appliances or modules have been pirated. With each new updating of this revocation list, an index is incremented and the revocation list as well as the update index are transmitted by the certifying authority to all the content providers to which it is linked.

Preferably, the revocation list contains serial numbers of modules, of appliances or of keys (in particular of the keys which it has issued) which are no longer regarded as safe by the certifying authority. It may also contain information relating to secret keys (used in so-called symmetric cryptography) used in the secure system for broadcasting content when the certifying authority has become aware of a pirating (for example of a public broadcasting of a secret key) of one of these keys.

Moreover, the revocation list also contains, in a preferred manner, for each element of the list, its revocation index, that is to say the update index of the revocation list at the moment of the insertion of the element Into the list. This advantageously makes it possible to manage the moment from which a key, an appliance or a module is no longer regarded as compliant and reliable by the certifying authority.

In the digital home network represented in FIG. 1, the reception device 3 comprises a digital decoder 30 fitted with a smart card reader furnished with a smart card 31. This decoder receives digital contents from the content provider 2 via a link 6. This may be a terrestrial, cable, satellite link or a link using the Internet network. Preferably, the decoder 30 also comprises a return pathway 7 to the content provider. This return pathway can in particular use the switched telephone network.

The reception device 3 of the home network also plays the role of source device in the network, that is to say it sends the contents received to other devices of the network, in particular the content presentation device 4 or the digital video recorder (DVCR) 5. The content presentation device 4 comprises a digital television receiver (DTV) 40 fitted with a smart card reader furnished with a smart card 41.

The digital data representing the content broadcast by the content provider 2 to the reception device 3 are generally data scrambled according to the principle of pay television or “conditional access” television. The data are scrambled with the aid of control words (CW) which are themselves transmitted in the data stream in a form encrypted with the aid of an encryption key K while being contained in control messages (ECM, standing for “Entitlement Control Message”). The encryption key K is placed at the disposal of users who have paid to receive the data, in particular by being stored in a smart card.

In the example of FIG. 1, it is assumed that the smart card 31 contains such a key K. We have also represented an exemplary packet of data 60 such as they are received by the reception device 3.

Naturally, the invention applies also to the case where the digital data are protected by a so-called DRM system (the initials standing for “Digital Rights Management”).

According to a preferred embodiment of the invention, when the data representative of a content are received by the decoder 30, they are subsequently shaped by the device 3 before being broadcast over the digital network. To do this, the ECM messages containing the control words CW encrypted with the aid of the key K are transformed, by a converter module 32 contained in the smart card 31, into LECM messages (the initials standing for “Local Entitlement Control Message”) containing the decrypted control words, the LECM messages being themselves protected with the aid of a key specific to the home network, In particular a secret key. An exemplary packet of data 80 flowing around the bus 8 of the home network is represented in FIG. 1.

According to the principle of the invention, when the content provider 2 transmits a content to the reception device 3, it attaches to the content the update index of the revocation list which the certifying authority has last transmitted to it.

This index Index_{LR}_{_{—}}_{C} is preferably contained in the ECM message while being protected by the key K. In particular, the index may be encrypted by the key K.

For its part, the reception device 3 contains a revocation list LR_M as well as an update index of this list Index_{LR}_{_{—}}_{M} which are preferably stored in the converter module 32 contained in the smart card 31.

In a first preferred variant of the invention, the smart cards such as the card 31 are delivered by the certifying authority to the users while containing among other things the latest up-to-date revocation list LR_M as well as the corresponding index Index_{LR}_{_{—}}_{M}. In a second variant embodiment, the cards do not contain any revocation list or any index when they are delivered to the users.

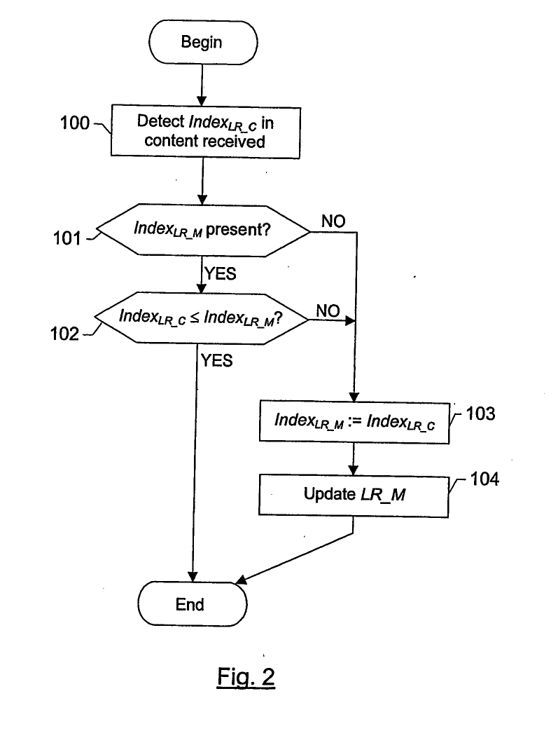

We shall now describe, in conjunction with FIG. 2, the process which is implemented when a new content is received in the home network by the reception device 3.

The first step 100 consists in detecting in the content received the update index of the revocation list Index_{LR}_{_{—}}_{C}.

The second step 101, which is implemented only in the second variant embodiment mentioned hereinabove, consists in verifying the presence in the reception device 3 of a revocation list stored update index Index_{LR}_{_{—}}_{M}. If an index Index_{LR}_{_{—}}_{M} is stored, then we go to step 102 consisting in verifying whether the index received in the content Index_{LR}_{_{—}}_{C} is less than or equal to the stored index Index_{LR}_{_{—}}_{M}. If Index_{LR}_{_{—}}_{C}<Index_{LR}_{_{—}}_{M}, the process is terminated.

Otherwise, we go to step 103 consisting in replacing the value of the revocation list stored update index Index_{LR}_{_{—}}_{M} by the index received in the content Index_{LR}_{_{—}}_{C}. Likewise, if the response to the test of step 101 is negative (no index stored in the reception device), then we go to step 103 and the stored index Index_{LR}_{_{—}}_{M} is initialized to the value of the index received in the content Index_{LR}_{_{—}}_{C}.

Following step 103, it is also necessary to update the stored revocation list LR_M in the reception device 3. This is shown diagrammatically in FIG. 2 by step 104 which can consist either in downloading the most recent revocation list by using the return pathway 7 from the decoder 30 to the content provider 2, or in awaiting reception of this list with a next content. In this case, it is envisaged that the content provider periodically sends the most recent revocation list with contents.

When the revocation list stored index Index_{LR}_{_{—}}_{M} as well as the corresponding revocation list LR_M have been updated in the reception device 3, the latter communicates them to the other devices of the network, with the exception of the recording devices such as the DVCR 5 in FIG. 1. In particular in the example of FIG. 1, it communicates them to the presentation device 4 which stores them in a terminal module 42 contained in the chip card 41.

This terminal module 42 contains in particular a secret key specific to the home network and it is responsible for processing the LECM messages included in the data packets 80 received by the presentation device 4. By virtue of this secret key of the home network, the terminal module 42 is capable of recovering from the LECM message the control words CW which served to scramble the digital data. The presentation device 4 can then descramble the data so as to present them to the user.

It will be noted that the invention applies also to the case where the digital home network comprises a pair of asymmetric keys which is specific to this network to protect the LECM messages.

Coming back to the reception device 3, when the latter has performed the steps 100 to 104 described previously, it transforms the ECM message included in the digital data received into an LECM message which furthermore contains the revocation list update index Index_{LR}_{_{—}}_{C} received with the content.

If this content, which flows around the digital home network in the form of data packets such as the packet 80 represented in FIG. 1, is recorded by the recording device 5, it will therefore be recorded with the most recent update Index of the revocation list at the moment of the recording, this index being included in the LECM messages of the packets which make up the content. In this way, it will always be possible for the content to be viewed or played in the network even if later on a key or an appliance of the network are revoked.

Preferably, the index Index_{LR}_{_{—}}_{C} inserted Into the LECM message by the converter module 32 is inserted into a “plaintext” part of this message.

The LECM message in fact comprises a plaintext part A containing in particular information regarding the type of content (audio/video . . . ) or regarding permission or otherwise to copy this content, and a protected part B containing in particular the control words which served to scramble the digital data representing the content. This part B is protected by encryption, that is to say the LECM message contains an encrypted version of the part B, encrypted with the aid of a key which is either the specific key of the network, or a key which can be retrieved by knowing the specific key of the network. The LECM message preferably also contains an integrity field which is the result of a hash function applied to the part A and to the part B (before encryption) of the message.

Let us recall that a hash function, often denoted “Hash(x)” is a mathematical function which transforms a data set “x” into a data set “y” of fixed size, often appreciably smaller than the size of the input data, and that this function is a one-way function, that is to say that knowing “y”, it is impossible to retrieve “x”, such that y=Hash(x).

In a variant embodiment, in particular when the LECM message does not comprise any integrity field, the index Index_{LR}_{_{—}}_{C} inserted into the LECM message by the converter module 32 is inserted into the protected part B of the LECM message.

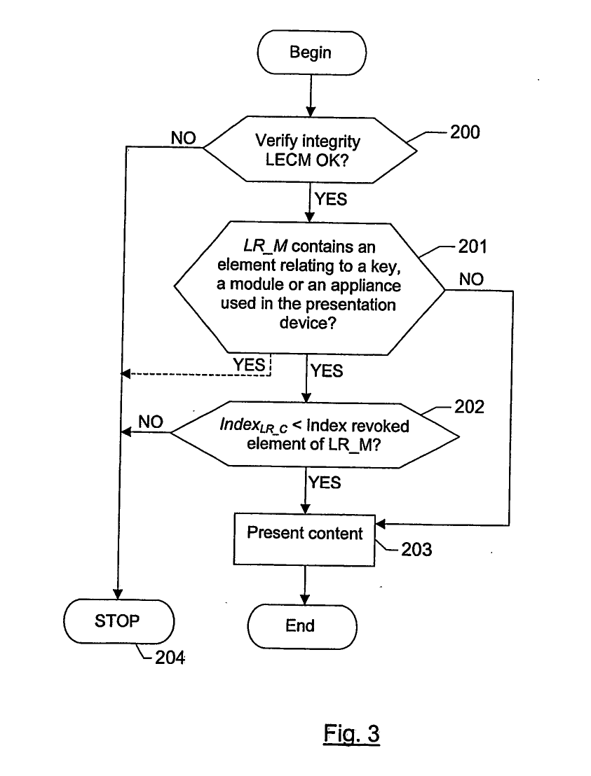

We shall now describe, in conjunction with FIG. 3, the process which is implemented by the presentation device 4 when a content originating from the digital home network is to be presented to a user, and more precisely when each data packet 80 of the content is received by the presentation device 4.

During a first step 200, the presentation device verifies the integrity of the LECM message included in the data packet received. To do this, it recovers the part B of the LECM message by virtue of the specific secret key of the home network and then it calculates the result of the same hash function as that mentioned above, applied to the parts A and B of the LECM message, so as to compare it with the integrity field of the LECM message received.

If this verification is positive, then the process is continued with step 201 during which one verifies whether the revocation list LR_M stored in the terminal module 42 contains at least one element relating to a key, a module or an appliance used in the presentation device. This may be the serial number of a public key used by the presentation device (and stored preferably in the terminal module 42), or else the serial number of the television receiver appliance 40 or of the terminal module 42, or else an item of information relating to the secret key of the home network, stored in the terminal module 42 also (this item of information may be a serial number of the secret key, the key itself or else the result of a hash function or of an encryption function applied to the key).

If the revocation list LR_M contains no element relating to a key, a module or an appliance used in the presentation device 4, then the latter can present the content to the user during step 203.

On the other hand, if the revocation list contains at least one of said elements, then the process is continued with step 202 consisting in verifying whether the revocation index of this element (the revocation index of the element being contained in the LR_M list) is greater than the index Index_{LR}_{_{—}}_{C} included in the content received (more precisely, included in the LECM message of the packet received). This can occur when a content, recorded before an element has been inserted into the revocation index, is subsequently replayed in the home network after the element has been inserted into the list.

If the above verification is positive, then the presentation device can present the content to the user in step 203.

Otherwise, the process is stopped (step 204) and the content is not presented to the user. The process is also stopped when the verification of the integrity of the LECM message in step 200 is negative. The process can also be stopped, as a nonpreferred variant, when at least one element relating to a key, a module or an appliance used in the presentation device is included in the revocation list LR_M (dotted arrow represented leaving step 201).

The invention is not limited to the embodiments which have been described hereinabove. In particular, the invention applies also to the case where a content is received by a single device forming a content reception and presentation device, without this device necessarily being included in a digital home network.

1. Process for updating a revocation list containing identifiers of keys, of appliances or of modules regarded as noncompliant by a trusted third party in a secure system for broadcasting content consisting:
in receiving in a reception device content from a content provider,
wherein a unique identifier is allotted to each update of the revocation list by the trusted third party, the identifier of the most recent revocation list being attached to the content received in said reception device, and
in that the process furthermore comprises a step consisting in comparing the revocation list identifier received with a revocation list identifier stored in said reception device and, in case of difference between said identifiers:
in downloading the most recent revocation list to said reception device; or
in awaiting the reception of the most recent revocation list with a next content.

2. Process for receiving a content by a reception device in a secure system for broadcasting content in which a revocation list, drawn up by a trusted third party, contains identifiers of keys, of appliances or of modules regarded as noncompliant by said trusted third party,
wherein a unique identifier is allotted to each update of the revocation list, the identifier of the most recent revocation list being attached to the content received by said reception device,
the process furthermore comprising a step consisting in
comparing the revocation list identifier received with a revocation list identifier stored in said reception device, and in case of difference between said identifiers:
in downloading the most recent revocation list to said reception device; or
in awaiting the reception of the most recent revocation list with a next content.

3. Process according to claim 1, wherein the revocation list unique identifier is an update index of said revocation list.

4. Process according to claim 1, wherein the identifier of the most recent revocation list which is received with the content is included in a part protected by encryption or by authentication of said content.

5. Process according to claim 1, wherein the revocation list contains at least one element belonging to the set comprising:
at least one serial number of a public key generated by said trusted third party and regarded as noncompliant by the trusted third party;
at least one serial number of an appliance regarded as noncompliant by the trusted third party;
at least one serial number of a module regarded as noncompliant by the trusted third party.

6. Process according to claim 1, wherein the revocation list contains at least one element belonging to the set comprising:
at least one local network secret key identifier serving to protect contents against illicit copying;
at least one local network secret key serving to protect contents against illicit copying;
at least the result of a calculation function, in particular a hash function, applied to a local network secret key serving to protect contents against illicit copying.

7. Process according to claim 5, wherein, for each element of the revocation list, its revocation index corresponding to the update index of said list at the moment of the insertion of the element into the revocation list is furthermore stored.

8. Process for presenting a content received in compliance with the process according to claim 2, wherein it comprises the steps consisting for a content presentation device in:
verifying whether the most recent revocation list at the disposal of the presentation device does not contain any element relating to at least one key, one module or one appliance used by said presentation device; and
if the revocation list does not contain any of said elements, continuing the process so as to present the content to a user,
otherwise, stopping the process.

9. Process for presenting a content received in compliance with the process according to claim 7, wherein it comprises the steps consisting in respect of a content presentation device in:
verifying whether the most recent revocation list at the disposal of the presentation device does not contain any element relating to at least one key, one module or one appliance used by said presentation device; and
if the revocation list contains at least one of said elements:
comparing the revocation list update index attached to the content (Index_{LR}_{_{—}}_{C}) with the revocation index of said element; and
if the revocation list update index attached to the content is less than the revocation index of said element, continuing the process so as to present the content to a user,
otherwise, stopping the process.
